(19) United States
(12) Patent Application Publication
(10) Pub. No.: US 2024/0176485 A1
(43) Pub. Date: May 30, 2024

(54) STORAGE MANAGEMENT SYSTEM AND METHOD FOR MANAGING STORAGE APPARATUS

(71) Applicant: Hitachi, Ltd., Tokyo (JP)

(72) Inventor: Keigo KOZAI, Tokyo (JP)

(73) Assignee: Hitachi, Ltd., Tokyo (JP)

(21) Appl. No.: 18/236,541

(22) Filed: Aug. 22, 2023

(30) Foreign Application Priority Data
Nov. 30, 2022 (JP) 2022-192228

(51) Int. Cl. G06F 3/06

(52) U.S. Cl. CPC G06F 3/0607; G06F 3/0631; G06F 3/0644; G06F 3/0647; G06F 3/0685

(57) ABSTRACT

To enable appropriate data migration scheduling between storage apparatuses. A system stores load information indicating a temporal change in a load of each of a plurality of storage apparatuses. The system selects a data migration source from the plurality of storage apparatuses based on the load information. The system estimates a data migration time length of a target volume selected from the data migration source based on a previously designated feature, which is related to the target volume or a combination of the data migration source and a data migration destination. The system generates a schedule indicating a data migration time period of the target volume based on the migration time length and the load information.

### CLAIM OF PRIORITY

The present application claims priority from Japanese patent application JP 2022-192228 filed on Nov. 30, 2022, the content of which is hereby incorporated by reference into this application.

### BACKGROUND OF THE INVENTION

### 1. Field of the Invention

The present invention relates to management of a plurality of storage apparatuses, and particularly to schedule setting of data migration between storage apparatuses.

### 2. Description of Related Art

In a storage operation, since how much capacity will be used in the future is unknown, the capacity tends to be prepared in a large amount. In such a case, in enterprise storage, it is possible to perform scale-out by adding a storage apparatus and connecting the storage apparatus to an existing storage system, and to achieve capacity addition/resource sharing.

On the other hand, the scale-out using hardware significantly increases costs. Therefore, especially in a mid-range/entry model, a scale-out operation using software is performed. The scale-out operation using software virtually manages one storage apparatus, and internally manages a plurality of physical storage apparatuses.

In the software scale-out, data is migrated between the plurality of physical storage apparatuses constituting the virtual storage apparatus. In the data migration, it is necessary to create a data migration plan in consideration of a load on the physical storage apparatuses, which is a heavy burden on a user. In addition, data migration between storage apparatuses can be executed for various purposes different from the software scale-out.

### CITATION LIST

### Patent Literature

PTL 1: JP2021-140404A

### SUMMARY OF THE INVENTION

In managing the plurality of physical storage apparatuses, it is required to monitor a load status of the physical storage apparatuses and periodically distribute the load. Since data migration between the physical storage apparatuses imposes a load on these physical storage apparatuses, the user needs to manually select a migration source storage apparatus, a migration destination storage apparatus, and a volume to be migrated, and execute a task. Data migration scheduling or execution setting is a heavy burden on the user.

An aspect of the invention provides a storage management system for managing a plurality of storage apparatuses, including: one or more processors; and one or more memory devices. The one or more memory devices store load information indicating a temporal change in a load of each of the plurality of storage apparatuses. The one or more processors select a data migration source from the plurality of storage apparatuses based on the load information, estimate a data migration time length of a target volume selected from the data migration source based on a previously designated feature, which is related to the target volume or a combination of the data migration source and a data migration destination, and generate a schedule indicating a data migration time period of the target volume based on the migration time length and the load information.

According to one aspect of the invention, it is possible to execute appropriate data migration scheduling between storage apparatuses.

### BRIEF DESCRIPTION OF THE DRAWINGS

FIG. 1 schematically shows a configuration example of a computer system according to an embodiment of the description;

FIG. 2 shows a configuration example of pool information;

FIG. 3 shows a configuration example of a part of information included in MP load information;

FIG. 4 shows a configuration example of volume information;

FIG. 5 shows a configuration example of training data;

FIG. 6 shows a configuration example of information included in data migration executable time information;

FIG. 7 shows a configuration example of task schedule information;

FIG. 8 shows a flowchart of entire processing executed by a storage management system;

FIG. 9 shows a flowchart of a processing example of a data migration target apparatus selection unit;

FIG. 10 is an example of a flowchart of a step of extracting a schedulable time for data migration in which a migration destination is an on-premise storage apparatus;

FIG. 11 is an example of a flowchart of a step of extracting a schedulable time for data migration in which the migration destination is an inner-cloud storage apparatus;

FIG. 12 is a flowchart of a processing example of a schedule setting unit; and

FIG. 13 shows a flowchart of a processing example of an estimated data migration time calculation formula update unit.

### DESCRIPTION OF EMBODIMENTS

Hereinafter, description may be divided into a plurality of sections or embodiments if necessary for convenience. Unless otherwise specified, the sections or embodiments are not independent of each other, but have a relation in which one section or embodiment is a modification, detailed description, supplementary description, or the like of a part or all of another section or embodiment. Hereinafter, when the number and the like (including quantity, numerical values, amounts, ranges, and the like) of elements are mentioned, these parameters are not limited to specific numbers and may be equal to or larger than the specific numbers or equal to or less than the specific numbers, unless otherwise specified and unless the specific numbers are clearly limited to specific numbers in principle.

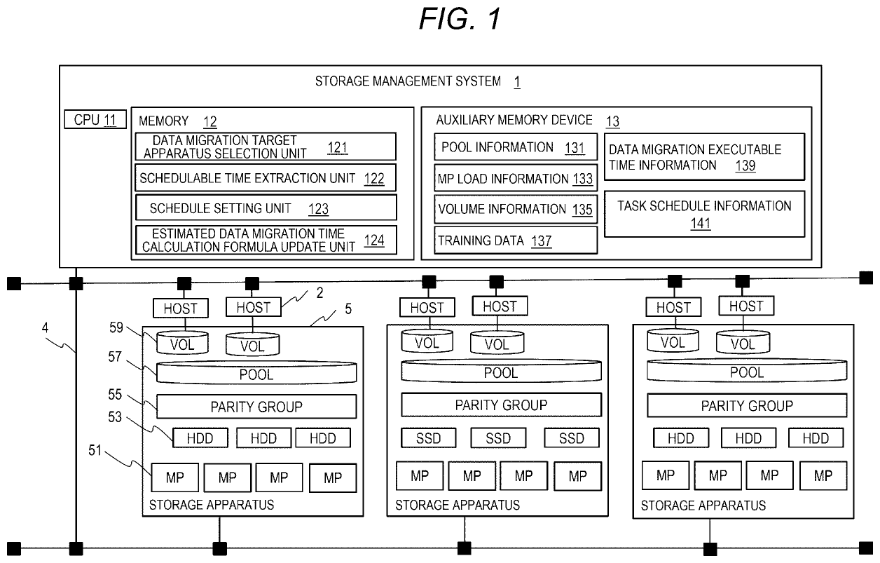

FIG. 1 schematically shows a configuration example of a computer system according to an embodiment of the description. The computer system includes a storage management system 1, host devices 2 (also simply referred to as hosts 2), and physical storage apparatuses 5 (also simply referred to as storage apparatuses 5) to be managed. In FIG. 1, for ease of explanation, one of the plurality of hosts is indicated by reference numeral 2 as an example. One of the plurality of storage apparatuses is indicated by reference numeral 5 as an example. Components of the storage apparatus indicated by reference numeral 5 are indicated by corresponding reference numerals as an example.

The storage management system 1 manages volume data migration between the storage apparatuses 5. The storage management system 1 can include one or more memory devices and one or more processors.

In the configuration example in FIG. 1, the storage management system 1 includes a CPU 11 as a processor having arithmetic performance, and a main memory 12 that provides a volatile memory area for storing programs and data to be executed by the CPU 11. The storage management system 1 further includes an auxiliary memory device 13 that provides a permanent information memory area using a hard disk drive (HDD), a flash memory, or the like.

The storage management system 1 can further include a network interface (not shown) that performs data communication with another device, an input device (not shown) that receives an operation from an administrator (user), and an output device (not shown) that presents an output result in each process to the administrator. The input device can include, for example, a mouse or a keyboard. The output device is, for example, a monitor or a printer. The computer system may further include a user terminal that accesses the storage management system 1 via a network 4. The user terminal has a computer configuration and can include a CPU, a memory, an auxiliary memory device, a communication interface, an input device, and an output device.

In FIG. 1, the main memory 12 of the storage management system 1 stores a plurality of programs. These programs are a data migration target apparatus selection unit 121, a schedulable time extraction unit 122, a schedule setting unit 123, and an estimated data migration time calculation formula update unit 124. These programs are loaded, for example, from the auxiliary memory device 13 into the main memory 12.

The auxiliary memory device 13 stores data to be referred to or processed by each program in the storage management system 1. The data stored in the auxiliary memory device 13 is loaded into the main memory 12 if necessary. In FIG. 1, the auxiliary memory device 13 stores pool information 131, MP load information 133, volume information 135, training data 137, data migration executable time information 139, and task schedule information 141.

By executing a program stored in the main memory 12, the CPU 11 operates as a functional unit that implements a function defined by the program. For example, by executing the program, the CPU 11 can function as the data migration target apparatus selection unit, the schedulable time extraction unit, the schedule setting unit, and the estimated data migration time calculation formula update unit.

The storage management system 1 may be a physical computer system (one or more physical computers), or a system constituted on a computing resource group (a plurality of computing resources) such as a cloud infrastructure. The computer system or the computing resource group includes one or more interface devices (for example, including a communication device and input and output devices), one or more memory devices (for example, including a memory (main memory) and an auxiliary memory device), and one or more processors.

When a function is implemented by executing a program by a processor, since predetermined processing is appropriately performed using a memory device and/or an interface device or the like, the function may be at least a part of the processor. The processing described with the function as a subject may be processing performed by a processor or a system including the processor.

The program may be installed from a program source. The program source may be, for example, a program distribution computer or a computer-readable memory medium (for example, a computer-readable non-transitory memory medium). Description of each function is an example, and a plurality of functions may be integrated into one function, or one function may be divided into a plurality of functions.

Each storage apparatus 5 includes one or more microprocessors (MP) 51. The microprocessor 51 is also simply referred to as the processor 51. In FIG. 1, as an example, one microprocessor in one storage apparatus is indicated by reference numeral 51. The microprocessor 51 processes input/output (IO) requests from the host 2 and executes and controls various operations of the storage apparatus 5.

The storage apparatus 5 includes a plurality of memory devices 53 for storing data including host data (also referred to as user data) from the host 2. The memory device 53 is, for example, a hard disk drive (HDD) or a solid state drive (SSD), and is also referred to as a drive or a disk. In FIG. 1, as an example, one memory device in one storage apparatus is indicated by reference numeral 53. In the example in FIG. 1, the types of the memory device are the same in one storage apparatus 5.

Each storage apparatus 5 provides one or more volumes (VOL) 59 to the host 2. The host 2 issues, to the storage apparatus 5, an IO request for the volume 59, that is, a write request and a read request for host data (also referred to as user data).

A logical memory area of the volume 59 is provided from a pool 57. The pool 57 is a logical memory area, to which a physical memory area of a parity group 55 is assigned. The parity group 55 includes the plurality of memory devices 53. The parity group 55 is also called a RAID group, and reduces a possibility of user data loss by generating and storing redundant data together with the user data. In response to the request from the host 2, the storage apparatus 5 stores the user data in the physical memory area provided by the memory device 53 and reads the user data from the physical memory area.

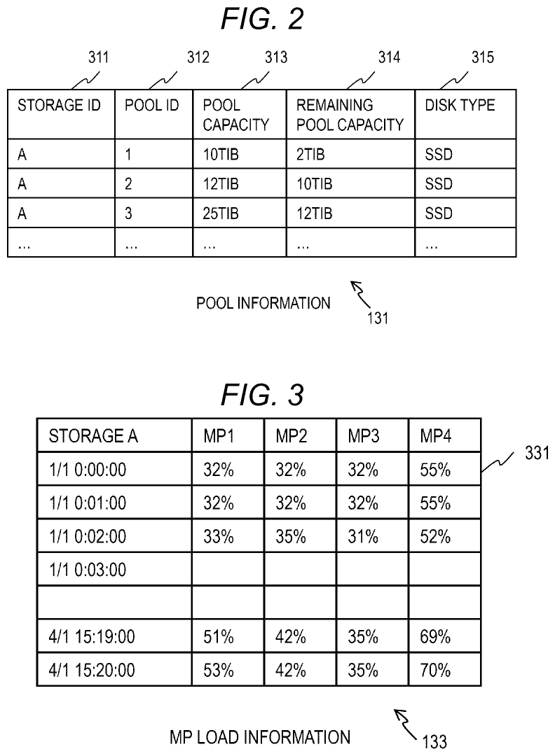

Hereinafter, management information held by the storage management system 1 will be described. FIG. 2 shows a configuration example of the pool information 131. The pool information 131 manages information on pools of the plurality of storage apparatuses 5 in the computer system. Information included in the pool information 131 may be acquired from each storage apparatus 5. In the configuration example in FIG. 2, the pool information 131 includes a storage ID column 311, a pool ID column 312, a pool capacity column 313, a remaining pool capacity column 314, and a disk type column 315. Each record indicates information on each pool of the plurality of storage apparatuses 5.

The storage ID column 311 indicates an ID for identifying the storage apparatus 5 in the computer system. The pool ID column 312 indicates an ID for identifying a pool in each storage apparatus 5. The pool capacity column 313 indicates a capacity of each pool. The remaining pool capacity column 314 indicates a remaining capacity of each pool, that is, a free area. The disk type column 315 indicates a type of a memory device (disk) that provides a physical memory area to each pool. Each pool is assigned only one type of memory device.

FIG. 3 shows a configuration example of a part of information included in the MP load information 133. The MP load information 133 manages information on a load of each microprocessor in each storage apparatus 5. FIG. 3 shows a table storing a load history of each microprocessor in one storage apparatus 5 (storage A). The information included in the MP load information 133 may be acquired from each storage apparatus 5.

In the example in FIG. 3, the number of microprocessors in the storage A is four (MP1 to MP4). Each record 331 indicates a usage rate of each processor in a specific time period. In FIG. 3, as an example, one record is indicated by reference numeral 331. The time periods have the same length, which is one minute in the example in FIG. 3. Lengths of the time periods may be different. Information on the usage rate of each microprocessor can be received from each storage apparatus 5. The MP load information 133 includes information on load histories of microprocessors in each of all the storage apparatuses 5 in the computer system.

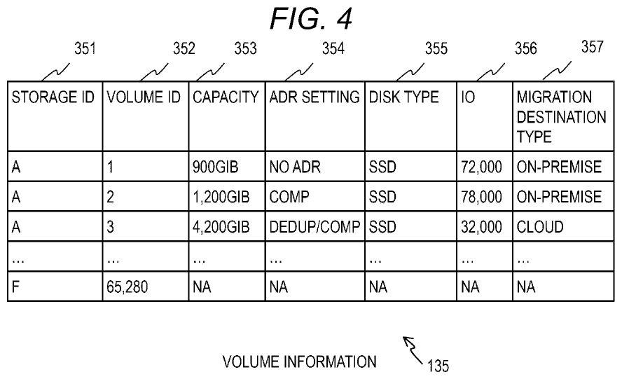

FIG. 4 shows a configuration example of the volume information 135. The volume information 135 manages information on volumes of the plurality of storage apparatuses 5 in the computer system. Information included in the volume information 135 may be acquired from each storage apparatus 5. In the configuration example in FIG. 4, the volume information 135 includes a storage ID column 351, a volume ID column 352, a capacity column 353, an ADR setting column 354, a disk type column 355, an IO column 356, and a migration destination type column 357. Each record indicates information on each volume of the plurality of storage apparatuses 5.

The storage ID column 351 indicates an ID for identifying the storage apparatus 5 in the computer system. The volume ID column 352 indicates an ID for identifying a volume in each storage apparatus 5. The capacity column 313 indicates a capacity of each volume.

The ADR setting column 354 indicates data reduction processing applied to each volume. ADR represents adaptive data reduction. In this example, the data reduction processing that can be applied to each volume is data compression (COMP) and deduplication (DEDUP). One or both of the data compression and deduplication can be applied to one volume. “No ADR” indicates that neither of the data reduction processing is applied. In addition to or instead of data conversion processing for data reduction, another data conversion processing, for example, presence or absence of encryption may be managed.

The disk type column 355 indicates a type of the memory device 53 that provides a physical memory area to each volume. The IO column 356 indicates information on the number of IOs (a sum of read requests and write requests) for each volume in a predetermined period, for example, one day. A value in the IO column 356 is, for example, a moving average in a predetermined number of days, and may be updated daily.

The migration destination type column 357 indicates whether a migration destination in volume migration is an on-premise storage apparatus or an inner-cloud storage apparatus. The on-premise storage apparatus means an internal storage apparatus under management of the user. The inner-cloud storage apparatus means an external storage apparatus provided via the Internet. Information in the columns 351 to 356 in the volume information 135 can be received from each storage apparatus 5. Information in the migration destination type column 357 is designated by the administrator.

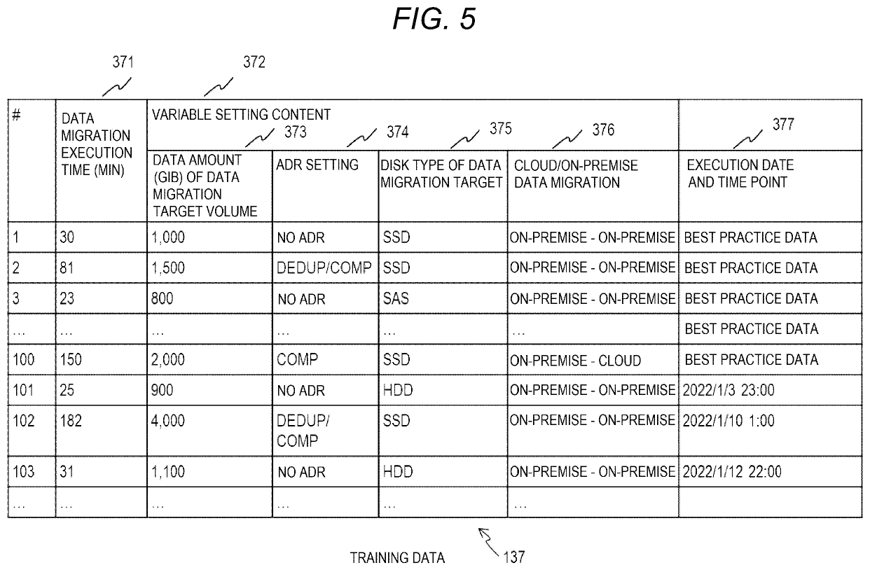

FIG. 5 shows a configuration example of the training data 137. The training data 137 stores training data for updating (training) a function (model) for estimating a time required for data migration between the storage apparatuses 5. The estimated data migration time calculation formula update unit 124 updates parameters of the function using the training data 137. Each record indicates information on one piece of training data. The training data 137 may include both preset initial data and data migration execution performance in a user environment.

In the example in FIG. 5, records in which a value in an execution date and time point column 377 is “best practice data” are data in a best practice environment provided in advance. The records, in which the value in the execution date and time point column 377 indicates a specific date and time point, indicate the execution performance in the user environment. As described later, the training data 137 is updated by the estimated data migration time calculation formula update unit 124 according to the execution performance in new data migration. Accordingly, more appropriate training data 137 is generated. The training data 137 may include only one of the initial data or the data migration execution performance in the user environment.

The training data 137 includes a data migration execution time column 371, a variable setting content column 372, and the execution date and time point column 377. The variable setting content column 372 includes a data amount of data migration target volume column 373, an ADR setting column 374, a disk type of data migration target column 375, and a cloud/on-premise data migration column 376.

The data migration execution time column 371 indicates an execution time of data migration between the storage apparatuses 5. The data amount of data migration target volume column 373 indicates a capacity of one migration target volume.

The ADR setting column 374 indicates ADR setting for a migration target volume. As described above, the ADR setting indicates any one of no data reduction processing (no ADR), only compression (COMP), only deduplication (DEDUP), and both the compression and the deduplication (DEDUP/COMP).

The disk type of data migration target column 375 indicates a type of a memory device that provides a physical memory area to a migration target volume. In this example, a migration source storage apparatus and a migration destination storage apparatus have the same disk type.

The cloud/on-premise data migration column 376 indicates whether each of the migration source storage apparatus and the migration destination storage apparatus is an inner-cloud storage apparatus or an on-premise storage apparatus. In this example, the migration source is always the on-premise storage apparatus.

The execution date and time point column 377 indicates an execution date and time point when data is migrated. As described above, the execution date and time point is not defined in the initial data. Records of the execution performance in the user environment indicate the date and time point when the volume migration is actually started.

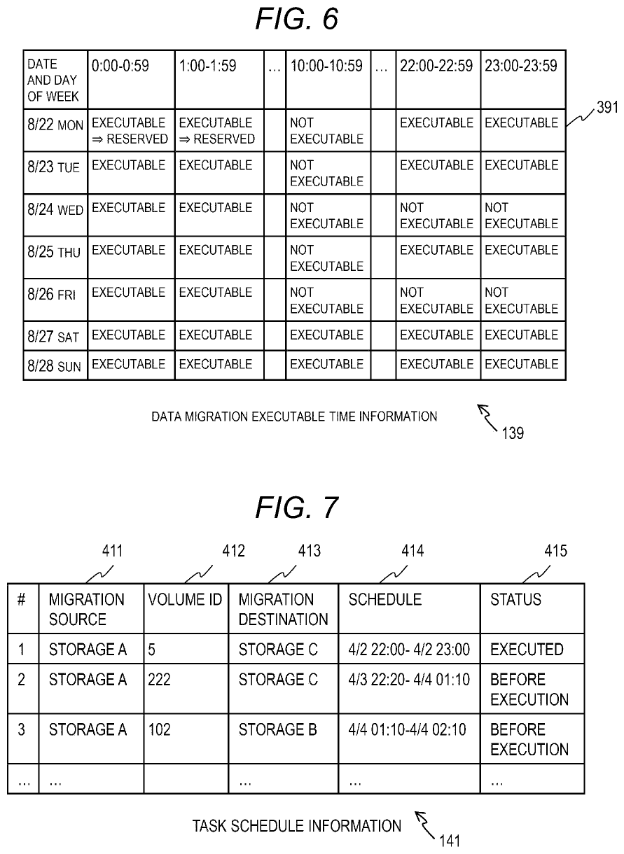

FIG. 6 shows a configuration example of information included in the data migration executable time information 139. The data migration executable time information 139 indicates a time during which data migration between the selected storage apparatuses 5 is executable. The data migration executable time information 139 is generated by the schedulable time extraction unit 122.

FIG. 6 shows a table of data migration executable time information on a set including a migration source storage apparatus and a migration destination storage apparatus selected as data migration targets. The data migration executable time information 139 is created for each combination of the migration source and the migration destination for executing data migration.

In the example in FIG. 6, each record 391 in the data migration executable time information 139 indicates a time period in which data migration is executable or not executable between target storage apparatuses on a specific date. In the example in FIG. 6, information on both date and day of a week is included. The time periods indicating executable/not executable have the same length, which is one hour. The time periods may be different. In FIG. 6, a cell indicating “executable and reserved” indicates that execution of data migration between storages is reserved in the time period.

FIG. 7 shows a configuration example of the task schedule information 141. The task schedule information 141 indicates information on a schedule for executing data migration between the storage apparatuses 5, and more specifically, indicates a list of scheduled data migration tasks. Each record indicates information on data migration that is unexecuted or executed between the storage apparatuses. The task schedule information 141 is generated and updated by the schedule setting unit 123.

The task schedule information 141 includes a migration source column 411, a volume ID column 412, a migration destination column 413, a schedule column 414, and a status column 415. The migration source column 411 indicates storage apparatuses as a data migration source. The volume ID column 412 indicates an ID of a volume to be migrated. The migration destination column 413 indicates a storage apparatus as the data migration destination. The schedule column 414 indicates a date and time point when data migration is executed. Specifically, a scheduled start date and time point and a scheduled end date and time point of data migration are indicated. The status column 415 indicates whether data migration is executed or is before execution for each record.

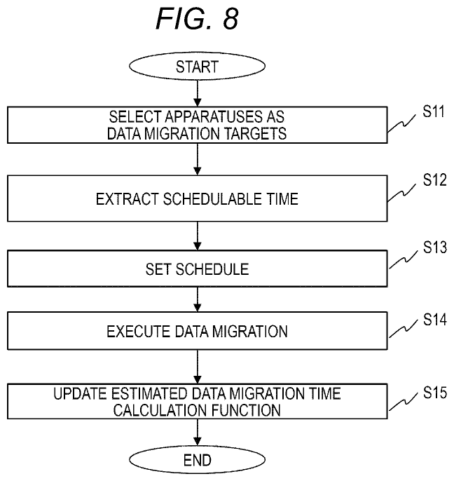

Hereinafter, data migration processing between the storage apparatuses executed by the storage management system 1 will be described. FIG. 8 shows a flowchart of the entire processing. The storage management system 1 generates a schedule of data migration between the storage apparatuses in the computer system, and executes the data migration according to the schedule. Further, the function for estimating the time required for the data migration is updated based on the training data 137 including information on executed data migration.

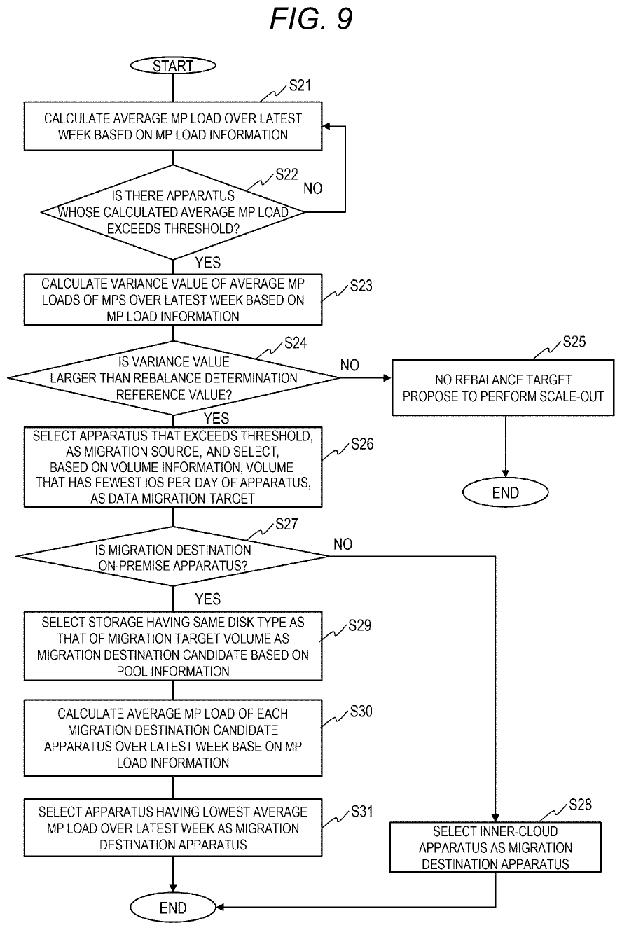

First, the data migration target apparatus selection unit 121 selects storage apparatuses 5 as data migration targets (S11). The data migration target apparatus selection unit 121 refers to the past MP load information 133 and determines whether it is necessary to execute data migration from each storage apparatus 5. When it is necessary to execute data migration, the data migration target apparatus selection unit 121 selects a data migration source storage apparatus 5, a data migration destination storage apparatus 5, and a volume 59 to be migrated. This step will be described later in detail with reference to FIG. 9.

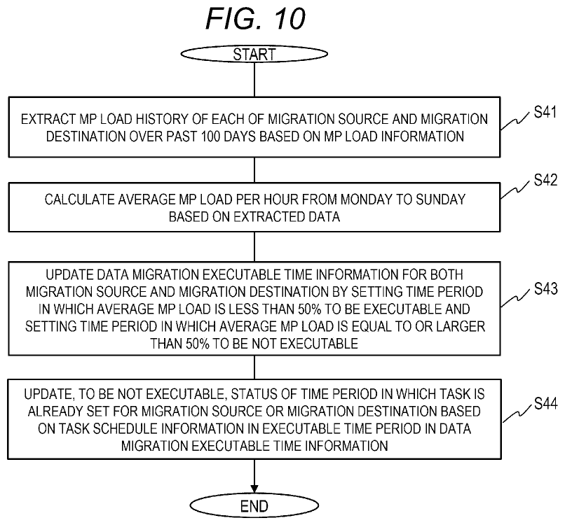

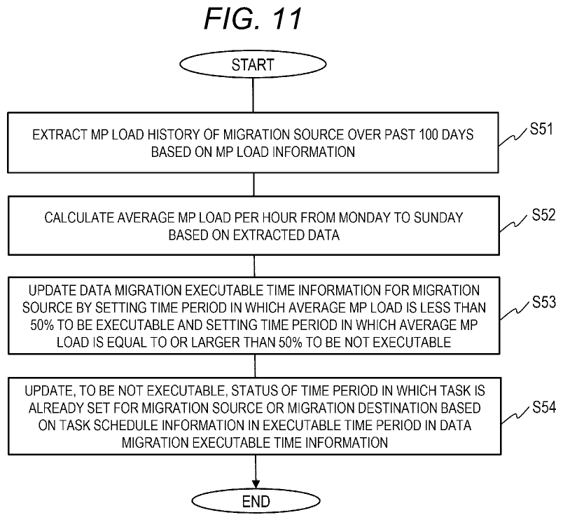

Next, the schedulable time extraction unit 122 extracts a schedulable time for data migration (S12). The schedulable time extraction unit 122 refers to the past MP load information 133 in the migration source storage apparatus 5 and the migration destination storage apparatus 5 selected in step S11, and estimates a schedulable time period. For example, a time period in which an average MP usage rate of the migration source storage apparatus 5 and the migration destination storage apparatus 5 is less than a predetermined value is determined as an executable time period. This step will be described later in detail with reference to FIGS. 10 and 11.

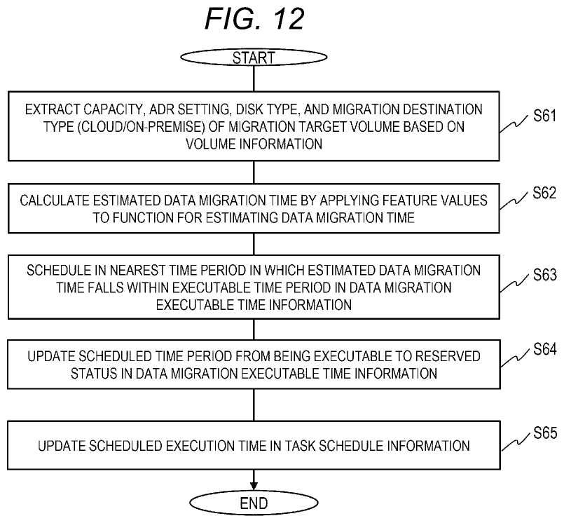

Next, the schedule setting unit 123 sets a schedule of data migration between the target storage apparatuses 5 (S13). The schedule setting unit 123 estimates a time required for the data migration, and reserves a data migration execution task in the time period in which data migration is executable. This step will be described later in detail with reference to FIG. 12.

Next, the storage management system 1 designates the volume 59 to be migrated to the migration source storage apparatus 5 and the migration destination storage apparatus 5, and instructs the migration source storage apparatus 5 and the migration destination storage apparatus 5 to execute data migration according to the set schedule. The instructed migration source storage apparatus 5 and migration destination storage apparatus 5 execute migration of the designated data (S14).

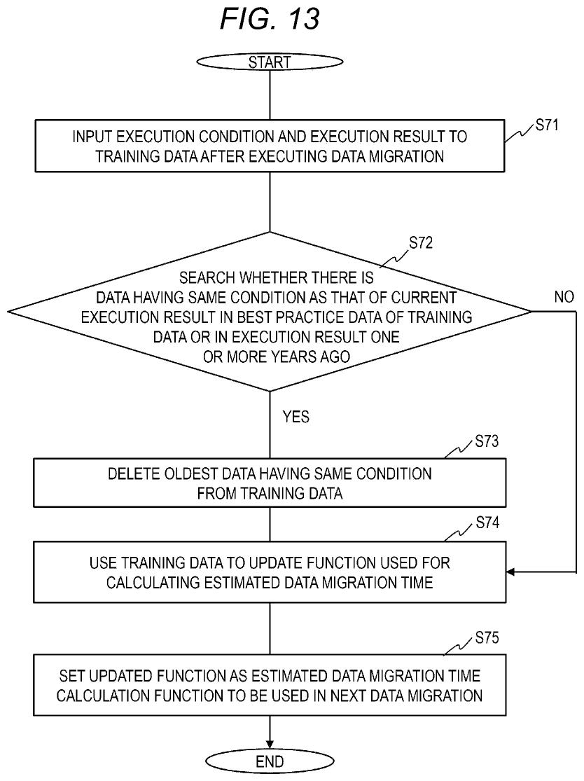

After the data migration is completed, the estimated data migration time calculation formula update unit 124 stores an execution condition and an execution result in the training data 137, deletes old data having the same condition, and uses the training data 137 to update an estimated data migration time calculation formula to be used in next data migration (S15). This step will be described later in detail with reference to FIG. 13.

The schedule setting unit 123 may present the schedule to the user. For example, information on the schedule is displayed on a display device of the storage management system 1 or a display device of the user terminal. The storage management system 1 may present the schedule to the user without instructing the storage apparatus 5 to execute data migration, and may cause the storage apparatus 5 to execute data migration according to an instruction from the user.

Next, step S11 of selecting apparatuses as data migration targets will be described in detail. FIG. 9 shows a flowchart of a processing example of the data migration target apparatus selection unit 121. The data migration target apparatus selection unit 121 may execute the processing shown in FIG. 9 every predetermined period, for example, every week.

First, the data migration target apparatus selection unit 121 refers to the MP load information 133 and calculates an average MP load of each storage apparatus 5 over the latest week (S21). Specifically, the average MP load of each storage apparatus 5 is calculated by calculating an average load of each microprocessor 51 in the storage apparatus 5 over the latest week, and further calculating an average of average loads of all the microprocessors 51 in the storage apparatus 5. Any period may be selected for average calculation.

Next, the data migration target apparatus selection unit 121 determines whether there is a storage apparatus 5 whose calculated average MP load exceeds a preset threshold (S22). When there is no storage apparatus 5 whose average MP load exceeds the threshold (S22: NO), the flow returns to step S21. As described above, step S21 is executed every predetermined period.

When there is a storage apparatus 5 whose average MP load exceeds the threshold (S22: YES), the data migration target apparatus selection unit 121 refers to the MP load information 133, calculates average MP loads of all the MPs 51 in all the storage apparatuses 5 over the latest week, and further calculates a variance value of these values (S23). Any period may be selected for average calculation, which may be the same as or different from that in step S21.

Next, the data migration target apparatus selection unit 121 determines whether the calculated variance value is larger than a preset rebalance determination reference value (S24). The variance value is an example of a value representing a variation in loads of the storage apparatuses. By observing the variation in loads of the storage apparatuses, it is possible to more appropriately determine whether an appropriate rebalance is possible.

When the variance value is equal to or less than the rebalance reference value (S24: NO), the data migration target apparatus selection unit 121 determines that there is no storage apparatus 5 as the data migration destination (rebalance target), and proposes the administrator to perform scale-out using hardware (S25). For example, a proposal screen is displayed on the display device of the storage management system 1 or the display device of the user terminal connected via the network 4.

When the variance value is larger than the rebalance reference value (S24: YES), the data migration target apparatus selection unit 121 determines the storage apparatus 5 whose average MP load exceeds the threshold as the migration source. Further, a volume having the fewest IOs per day of the storage apparatus 5 is selected as the data migration target based on the volume information 135 (S26). When the average MP loads of the plurality of storage apparatuses 5 exceed the threshold, all of these storage apparatuses 5 are determined as migration source storage apparatuses, and one volume 59 is selected from each migration source storage apparatus 5 as described above. It is estimated that an access delay occurs in the storage apparatus 5 having a high MP load. It is estimated that an access delay occurs in the volume 59 having few IOs.

Next, the data migration target apparatus selection unit 121 refers to the volume information 135, and determines whether the migration destination is an on-premise storage apparatus 5 or an inner-cloud storage apparatus 5 for each migration target volume (S27). When the migration destination is not the on-premise storage apparatus 5 (S27: NO), the data migration target apparatus selection unit 121 sets the inner-cloud storage apparatus 5 as the migration destination (S28).

Steps S29 to S31 are executed for each of the migration source storage apparatuses 5 for which the migration destination is the on-premise storage apparatus 5. That is, the data migration target apparatus selection unit 121 refers to the pool information 131 and selects the storage apparatus 5 having the same disk type as that of the migration target volume 59 as a migration destination candidate (S29). Accordingly, access performance close to that of the migration source can also be obtained at the migration destination.

Next, the data migration target apparatus selection unit 121 refers to the MP load information 133 and calculates an average MP load of each migration destination candidate storage apparatus 5 over the latest week (S30). A method for calculating the average MP load is the same as that in step S21. Further, the data migration target apparatus selection unit 121 selects a storage apparatus having the lowest average MP load over the latest week as the migration destination storage apparatus 5 (S31). Accordingly, it is possible to migrate data to a storage apparatus having a relatively low load.

Next, step S12 of extracting a schedulable time will be described in detail. First, with reference to FIG. 10, step S12 of extracting a schedulable time for data migration when the migration destination is the on-premise storage apparatus 5 will be described. Processing to be described below is executed on storage apparatuses 5 that are sequentially selected from the migration source storage apparatuses 5 selected in step S11 of selecting apparatuses as data migration targets. A selection order may, for example, start from a storage apparatus having a high average MP load, or may be any order.

Referring to FIG. 10, the schedulable time extraction unit 122 extracts an MP load history of each of the migration source storage apparatus and the migration destination storage apparatus over the past 100 days based on the MP load information 133 (S41). Any period may be selected for extraction.

The schedulable time extraction unit 122 calculates the average MP load per hour from Monday to Sunday based on the extracted data (S42). Since the load of the storage apparatus 5 generally changes according to the day of the week and the time, it is possible to appropriately find a time period in which the load of the storage apparatus 5 is low.

Next, the schedulable time extraction unit 122 updates the data migration executable time information 139 for both the migration source storage apparatus 5 and the migration destination storage apparatus 5 by setting a time period in which the average MP load is less than the threshold as an executable time period and setting a time period in which the average MP load is equal to or larger than the threshold as a not executable time period (S43). The threshold may be, for example, 50% and is appropriately set according to design. By referring to the loads of both storage apparatuses, data migration can be efficiently performed.

Next, the schedulable time extraction unit 122 updates, to be not executable, a status of a time period in which a task is already set for the migration source storage apparatus 5 or the migration destination storage apparatus 5 based on the task schedule information 141 in an executable time period in the data migration executable time information 139 (S44).

Next, with reference to FIG. 11, step S12 of extracting a schedulable time for data migration when the migration destination is the inner-cloud storage apparatus will be described. When the migration destination is the inner-cloud storage apparatus, a load of only the migration source storage apparatus 5 is referred to.

First, the schedulable time extraction unit 122 extracts an MP load history of the migration source storage apparatus 5 over the past 100 days based on the MP load information 133 (S51). Any period may be selected for extraction.

The schedulable time extraction unit 122 calculates the average MP load per hour from Monday to Sunday based on the extracted data (S52). Since the load of the storage apparatus 5 generally changes according to the day of the week and the time, it is possible to appropriately find a time period in which the load of the storage apparatus 5 is low.

Next, the schedulable time extraction unit 122 updates the data migration executable time information 139 for the migration source storage apparatus 5 by setting a time period in which the average MP load is less than the threshold as an executable time period and setting a time period in which the average MP load is equal to or larger than the threshold as a not executable time period (S53). The threshold may be, for example, 50% and is appropriately set according to design. Accordingly, data migration can be efficiently performed.

Next, the schedulable time extraction unit 122 updates, to be not executable, a status of a time period in which a task is already set for the migration source storage apparatus 5 based on the task schedule information 141 in an executable time period in the data migration executable time information 139 (S54).

Next, step S13 of schedule setting will be described in detail. FIG. 12 is a flowchart of a processing example of the schedule setting unit 123. The schedule setting unit 123 extracts information on the capacity, the ADR setting, the disk type, and the migration destination type (cloud/on-premise) of the migration target volume based on the volume information 135 (S61). Next, the schedule setting unit 123 calculates an estimated data migration time of the target volume by applying feature values acquired in step S61 to a function for estimating the data migration time (S62). An estimated data migration time y may be calculated using, for example, the following function.

y=β1x1+β2x2+β3x3+β4x4

β1 to β4 are variable parameters, x1 to x4 are explanatory variables, and y is an objective variable. The variable parameters are updated using the training data 137. In this example, the variable x1 is the capacity of the migration target volume, the variable x2 is a value assigned to the ADR setting, the variable x3 is a value assigned to the disk type, and the variable x4 is a value assigned to the migration destination type. A data amount of the volume may be, instead of the capacity of the volume, the amount of user data in the volume.

Thus, in this example, when the data migration execution time is estimated, the data amount, the ADR setting, the disk type, and the cloud/on-premise data migration are provided as feature values. By using these variables, it is possible to appropriately estimate the data migration time.

Since the data migration time may be changed according to the data amount, it is possible to improve data migration time estimation accuracy by setting the data amount as a feature value. Since processing is added to the data migration according to the ADR setting and the data migration time changes, it is possible to improve the data migration time estimation accuracy by setting the ADR setting as a feature value. During the data migration, data after compression or deduplication is converted into data before compression or deduplication (also referred to as plaintext data).

Since a time for data read and write processing is different and the data migration time can change depending on the disk type, it is possible to improve the data migration time estimation accuracy by setting the disk type as a feature value. Since a value affecting the data migration time, such as a data transfer speed, can change depending on cloud/on-premise as the migration destination, it is possible to improve the data migration time estimation accuracy by setting the migration destination as a feature value. A part of these variables may be omitted, or other types of variables may be added.

Next, the schedule setting unit 123 schedules volume migration processing in the nearest time period from a current time in which the estimated data migration time falls within a consecutive executable time period in the data migration executable time information 139 (S63). Accordingly, it is possible to achieve a more appropriate rebalance. A time period different from the nearest time period may be set. The volume migration processing may be executed in a plurality of separated time periods.

Next, the schedule setting unit 123 updates the scheduled time period from being executable to a reserved status in the data migration executable time information 139 (S64). Finally, the schedule setting unit 123 updates a scheduled execution time in the task schedule information 141 (S65).

Next, step S15 of updating an estimated data migration time calculation function will be described in detail. FIG. 13 shows a flowchart of a processing example of the estimated data migration time calculation formula update unit 124. The estimated data migration time calculation formula update unit 124 updates the training data 137 according to the execution performance of data migration. Parameters of the estimated data migration time calculation function are updated using the updated training data 137.

First, the estimated data migration time calculation formula update unit 124 inputs an execution condition and an execution result to the training data 137 after executing the data migration between the storage apparatuses (S71). As shown in FIG. 5, records of the training data 137 include the data migration execution time column 371 and the variable setting content column 372. Values input to the variable setting content column 372 include the data amount of the migration target volume, and the ADR setting, the disk type, and the migration destination type (cloud/on-premise) of the volume.

Next, the estimated data migration time calculation formula update unit 124 searches whether there is a record having the same condition as that of a current execution result in the best practice data of the training data 137 or in an execution result one or more years ago (S72). The record having the same condition as that of the execution result is a record in which all the values in the variable setting content column 372 are the same.

The estimated data migration time calculation formula update unit 124 deletes the oldest record having the same condition from the training data 137 (S73). Accordingly, the training data 137 can be appropriately updated with new data.

Next, the estimated data migration time calculation formula update unit 124 updates the function used for calculating the estimated data migration time based on the training data 137 (S74). An update method depends on a configuration of the function. As described above, the function may be a function used in multiple regression analysis or a model (function) based on machine learning. The estimated data migration time calculation formula update unit 124 sets the updated function as the estimated data migration time calculation function to be used in next data migration (S75).

As described above, in the embodiment of the description, the estimated data migration time calculation function is updated based on the training data. The best practice data is provided as initial values of the training data, and the execution performance in the user environment is added to the training data. Accordingly, the function can be optimized for the user environment.

The invention is not limited to the above-described embodiment, and includes various modifications. For example, the above-described embodiment is described in detail to facilitate understanding of the invention, and the invention is not necessarily limited to those including all the configurations described above. A part of a configuration according to one embodiment can be replaced with a configuration according to another embodiment, and a configuration according to one embodiment can also be added to a configuration according to another embodiment. A part of a configuration according to each embodiment may be added, deleted, or replaced with another configuration.

A part or all of the above configurations, functions, processing units, and the like may be implemented by hardware, for example, by designing an integrated circuit. In addition, each of the above configurations, functions, and the like may be implemented by software by a processor interpreting and executing a program for implementing each function. Information such as a program, a table, and a file for implementing each of the functions can be stored in a recording device such as a memory, a hard disk, or an SSD, or in a recording medium such as an IC card, an SD card, or the like.

Control lines and information lines considered to be necessary for description are shown, and not all control lines and information lines are necessarily shown in a product. In practice, it may be considered that almost all the configurations are connected to each other.

What is claimed is:

1. A storage management system for managing a plurality of storage apparatuses, comprising:
one or more processors; and
one or more memory devices, wherein
the one or more memory devices store load information indicating a temporal change in a load of each of the plurality of storage apparatuses, and
the one or more processors select a data migration source from the plurality of storage apparatuses based on the load information, estimate a data migration time length of a target volume selected from the data migration source based on a previously designated feature, which is related to the target volume or a combination of the data migration source and a data migration destination, and generate a schedule indicating a data migration time period of the target volume based on the migration time length and the load information.

2. The storage management system according to claim 1, wherein
the one or more processors select the data migration destination from the plurality of storage apparatuses and an external system, and
the feature includes a feature indicating whether the data migration destination is selected from either the plurality of storage apparatuses or the external system.

3. The storage management system according to claim 1, wherein
the one or more processors return data subjected to data conversion and stored in a volume to data before the data conversion and migrate the data in data migration between the storage apparatuses, and
the feature includes a feature indicating data conversion during storage in the target volume.

4. The storage management system according to claim 1, wherein
the data migration source and the data migration destination have a same type of physical storage apparatus configured to store the data in the target volume, and
the feature includes a feature indicating the type of the physical storage apparatus.

5. The storage management system according to claim 1, wherein
the load information indicates a temporal change in a load of a processor of each of the plurality of storage apparatuses.

6. The storage management system according to claim 1, wherein
the one or more processors refer to the load information and calculate a value representing a variation in loads of the plurality of storage apparatuses, and generate the schedule when the calculated value is larger than a preset reference value.

7. The storage management system according to claim 1, wherein
the one or more processors determine, as the target volume, a volume having fewest input and output requests in a predetermined period at the data migration source.

8. The storage management system according to claim 1, wherein
the one or more processors select the data migration destination from the plurality of storage apparatuses, refer to the load information and determine loads of the data migration source and the data migration destination in each predetermined time period for each day of a week, and determine a predetermined time period in which the loads of the data migration source and the data migration destination are less than a threshold as a data migration executable time period, and
a time period selected from the data migration executable time period is included in the schedule.

9. The storage management system according to claim 1, wherein
the one or more memory devices store training data, and
the one or more processors estimate the migration time length using a preset function, update a parameter of the function using the training data, and update the training data according to a data migration execution result.

10. A method for managing a plurality of storage apparatuses, executed by a system storing load information indicating a temporal change in a load of each of the plurality of storage apparatuses, the method comprising:
selecting a data migration source from the plurality of storage apparatuses based on the load information;
estimating a data migration time length of a target volume selected from the data migration source based on a previously designated feature, which is related to the target volume or a combination of the data migration source and a data migration destination; and
generating a schedule indicating a data migration time period of the target volume based on the migration time length and the load information.
